(19) United States
(12) Patent Application Publication
(10) Pub. No.: US 2025/0168882 A1
(43) Pub. Date: May 22, 2025

(54) WIRELESS TRANSCEIVER DEVICE, WIRELESS TRANSMISSION HANDLING METHOD THEREOF, AND WIRELESS COMMUNICATION SYSTEM

(71) Applicant: Realtek Semiconductor Corporation, Hsinchu (TW)

(72) Inventors: Chun-Kai TSENG, Hsinchu (TW); Shau-Yu CHENG, Hsinchu (TW); Wen-Yung LEE, Hsinchu (TW); Chia-Yu HSU, Hsinchu (TW)

(21) Appl. No.: 18/948,427

(22) Filed: Nov. 14, 2024

(30) Foreign Application Priority Data
Nov. 21, 2023 (TW) 112144999

(51) Int. Cl. H04W 74/0816; H04L 1/00; H04W 52/24; H04W 52/36

(52) U.S. Cl. CPC H04W 74/0816; H04L 1/0003; H04W 52/242; H04W 52/367

(57) ABSTRACT

A wireless transceiver device includes a communication module and a processor. The communication module is configured to receive and transmit radio frequency signals. The processor is coupled to the communication module and is configured to perform the following operations: estimating a receiving path loss from the wireless transceiver device to an overlap basic service set (OBSS) receiving node when detecting an OBSS packet by the communication module; determining a spatial reuse transmission power used for a spatial reuse transmission by the communication module; determining a spatial reuse modulation coding scheme (MCS) index adopted for the spatial reuse transmission according to a normal MCS index adopted in a normal transmission by the communication module and a power drop of the spatial reuse transmission power relative to the normal transmission power; and performing the spatial reuse transmission when the spatial reuse MCS index meets a predetermined condition.

### RELATED APPLICATIONS

This application claims priority to Taiwan Application Ser. No. 112144999, filed Nov. 21, 2023, which is herein incorporated by reference.

### BACKGROUND

### Technical Field

The present disclosure relates to spatial reuse transmission, and more particularly to a wireless transceiver device, a wireless transmission handling method thereof, and a wireless communication system that can avoid severe interferences with an overlapping basic service set (OBSS) node in performing a spatial reuse transmission.

### Description of Related Art

The IEEE 802.11ax standard specifies a spatial reuse mechanism, which aims to have wireless resources of the same frequency band of overlapped basic service sets (BSSs) reusable for increasing the usage efficiency of the frequency band. However, with the densification of wireless communication systems, the BSSs become closer, and the interference between the BSSs also increases, thereby affecting transmissions of the whole system.

### SUMMARY

One aspect of the present disclosure directs to a wireless transceiver device which includes a communication module and a processor. The communication module is configured to receive and transmit radio frequency (RF) signals. The processor is coupled to the communication module, and is configured to perform the following operations: estimating a transmission path loss from the wireless transceiver device to an OBSS receiving node in response to detecting, by the communication module, an OBSS packet from an OBSS transmitting node, in which the OBSS receiving node is a destination of the OBSS packet; determining a spatial reuse transmission power that is used to perform a spatial reuse transmission by the communication module according to the transmission path loss; determining a spatial reuse modulation and coding scheme (MCS) index that is used to perform the spatial reuse transmission by the communication module according to a normal MCS index that is used to perform a normal transmission by the communication module and a power drop of the spatial reuse transmission power that is relative to a normal transmission power used to perform the normal transmission by the communication module; and utilizing the spatial reuse MCS index and the spatial reuse transmission power to perform the spatial reuse transmission in a case in which the spatial reuse MCS index meets a predetermined condition.

Another aspect of the present disclosure directs to a wireless transmission handling method which is adapted to a wireless transceiver device and includes: estimating a transmission path loss from the wireless transceiver device to an OBSS receiving node in response to detecting an OBSS packet from an OBSS transmitting node, in which the OBSS receiving node is a destination of the OBSS packet; determining a spatial reuse transmission power that is used to perform a spatial reuse transmission by the wireless transceiver device according to the transmission path loss; determining a spatial reuse MCS index for the spatial reuse transmission according to a normal MCS index that is used to perform a normal transmission by the wireless transceiver device and a power drop of the spatial reuse transmission power that is relative to a normal transmission power used to perform the normal transmission by the wireless transceiver device; and utilizing the spatial reuse MCS index and the spatial reuse transmission power to perform the spatial reuse transmission in a case in which the spatial reuse MCS index meets a predetermined condition.

Yet another aspect of the present disclosure directs to a wireless communication system which includes a first wireless transceiver device and a second wireless transceiver device that is configured to wirelessly communication connect to the first wireless transceiver device and belongs to the same BSS as the first wireless transceiver device. The second wireless transceiver device is configured to perform the following operations: estimating a transmission path loss from the second wireless transceiver device to an OBSS receiving node in response to detecting an OBSS packet from an OBSS transmitting node, in which the OBSS receiving node is a destination of the OBSS packet; determining a spatial reuse transmission power that is used to perform a spatial reuse transmission by the second wireless transceiver device according to the transmission path loss; determining a spatial reuse MCS index for the spatial reuse transmission according to a normal MCS index that is used to perform a normal transmission by the second wireless transceiver device and a power drop of the spatial reuse transmission power that is relative to a normal transmission power used to perform the normal transmission by the second wireless transceiver device; and utilizing the spatial reuse MCS index and the spatial reuse transmission power to perform the spatial reuse transmission in a case in which the spatial reuse MCS index meets a predetermined condition.

### BRIEF DESCRIPTION OF THE DRAWINGS

The foregoing aspects and many of the accompanying advantages of the present disclosure will become more readily appreciated as the same becomes better understood by reference to the following detailed description, when taken in conjunction with the accompanying drawings.

FIG. 1 is a schematic diagram of a wireless communication system in accordance with some embodiments of the present disclosure.

FIG. 2 is a schematic block diagram of a wireless transceiver device in accordance with some embodiments of the present disclosure.

FIG. 3 is a flowchart of a wireless transmission handling system in accordance with some embodiments of the present disclosure.

### DETAILED DESCRIPTION

The detailed explanation of the present disclosure is described as following. The described preferred embodiments are presented for purposes of illustrations and description, and they are not intended to limit the scope of the present disclosure.

In the context, wireless transceiver devices can be used to represent a number of different embodiments, including but not limited to, mobile wireless transceiver devices such as stations (STAs), laptops, mobile phones, tablet computers, and/or fixed wireless transceiver devices such as access points (APs), routers, switches, computer equipment, server equipment, and workstations. In addition, wireless transceivers can support multiple-input multiple-output (MIMO) transmissions, multiple-input single-output (MISO) transmissions, single-input multiple-output (SIMO) transmissions, and/or single-input single-output (SISO) transmissions.

According to the current Wi-Fi system specifications, the transmission modes adopted in the Wi-Fi system may include orthogonal frequency division multiplexing (OFDM) transmission modes, High Throughput (HT) modes, Very High Throughput (VHT) modes, High Efficiency (HE) modes, and Extremely High Throughput (EHT) modes, in which the HT modes, the VHT modes, the HE modes, and the EHT modes respectively correspond to various generations of wireless local area networks (WLANs) such as Wi-Fi 4, Wi-Fi 5, Wi-Fi 6, and Wi-Fi 7. More transmission modes are usable for a wireless transceiver device if the hardware specification thereof is better and the Wi-Fi system supported thereby is more advanced. The embodiments of the present disclosure may also be applied to other wired and/or wireless communication technologies such as cellular network, Bluetooth, local area network (LAN) and/or Universal Serial Bus (USB).

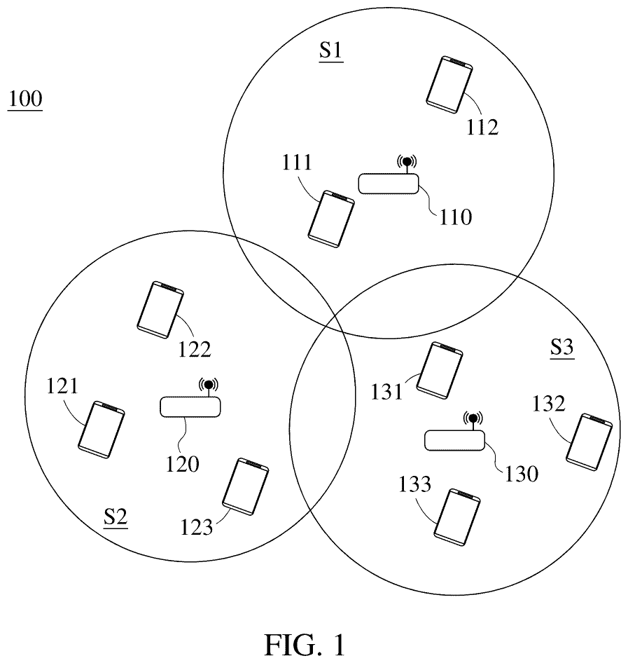

FIG. 1 is a schematic diagram of a wireless communication system 100 in accordance with some embodiments of the present disclosure. The wireless communication system 100 includes wireless access point devices 110, 120, and 130 and wireless terminal devices 111-112, 121-123, and 131-133. The wireless communication system 100 supports the Wi-Fi system specifications, and the wireless access point devices 110, 120, and 130 and the wireless terminal devices 111-112, 121-123, and 131-133 may be APs and STAs in the Wi-Fi system specifications, respectively. The wireless access point devices 110, 120, and 130 respectively provide wireless access services within a certain range, and the wireless terminal devices 111-112, 121-123, and 131-133 may perform wireless communication connections respectively with the wireless access point devices 110, 120, and 130 through a Wi-Fi channel (e.g., an IEEE 802.11 channel) to access a local area network and/or an external network (e.g., the Internet). The wireless communication connections between the wireless access point device 110 and the wireless terminal devices 111-112, the wireless communication connections between the wireless access point device 120 and the wireless terminal devices 121-123, and the wireless communication connections between the wireless access point device 130 and the wireless terminal devices 131-133 may include, but not limited to, registration procedures, authentication procedures and access procedures, establishment and release of wireless connections, and transmissions and/or receptions of control signals and/or transmissions and/or receptions of data signals.

As shown in FIG. 1, the wireless access point device 110 and the wireless terminal devices 111 and 112 belong to a BSS S1, the wireless access point device 120 and the wireless terminal devices 121, 122, and 123 belong to a BSS S2, and the wireless access point device 130 and the wireless terminal devices 131, 132, and 133 belong to a BSS S3. The BSSs S1-S3 are OBSSs with respect to each other. For example, as to the wireless access point device 110 and the wireless terminal devices 111 and 112 belonging to the BSS S1, the BSSs S2 and S3 are OBSSs. The wireless communication system 100 supports technologies of spatial reuse and BSS coloring.

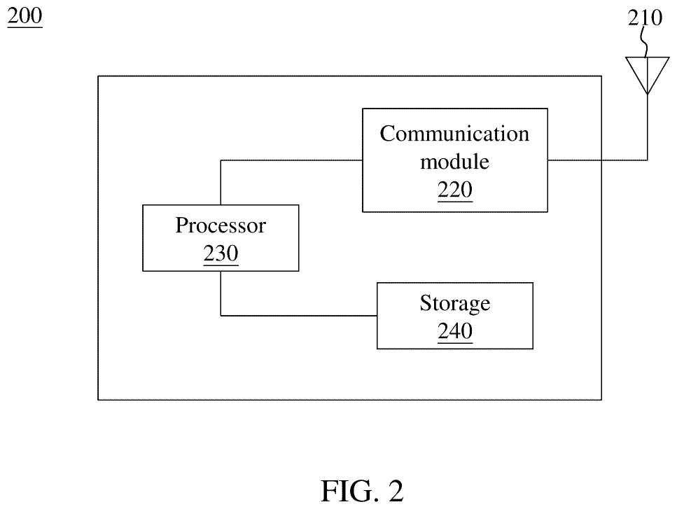

FIG. 2 is a schematic block diagram of a wireless transceiver device 200 in accordance with some embodiments of the present disclosure. The wireless transceiver device 200 may be any one of the wireless access point devices 110, 120, and 130 and the wireless terminal devices 111-112, 121-123, and 131-133 in FIG. 1. The wireless transceiver device 200 includes an antenna 210, a communication module 220, a processor 230, and a storage 240. The antenna 210 is configured for radio frequency signal transmissions and receptions. In some embodiments, the wireless transceiver device 200 may include multiple antennas 210 that may be configured to perform multiple-inputs and/or multiple-output RF signal transmissions and receptions. The communication module 220 is coupled to the antenna 210 and is configured to receive and demodulate RF signals into packets (e.g., control signals or data signals) and to modulate packets that are to be transmitted into RF signals. The processor 230 is coupled to the communication module 220 and the storage 240 and is configured to process packets and determine the transmission mode of the communication module 220 according to the system status for performing signal transmissions and receptions. The processor 230 may be, for example, but not limited to, a microprocessor or an application-specific integrated circuit (ASIC). The storage 240 may be any data storage device that can be read and executed by the processor 230. The storage 240 may be, for example, but not limited to, a subscriber identity module (SIM), a read-only memory (ROM), an erasable programmable ROM (EPROM), an electrically erasable programmable ROM (EEPROM), a random access memory (RAM), a CD-ROM, a magnetic tape, a hard disk drive, a solid-state drive, a flash memory, or another data storage device suitable for storing bit data and/or program codes.

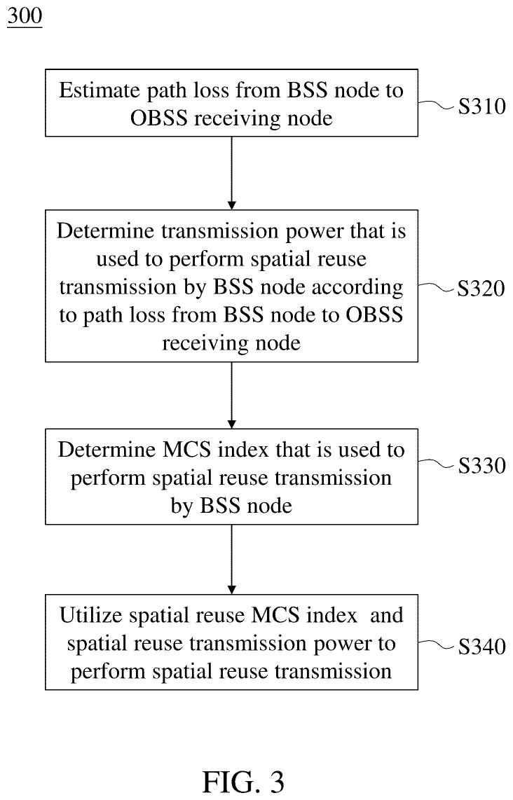

FIG. 3 is a flowchart of a wireless transmission handling method 300 in accordance with some embodiments of the present disclosure. The wireless transmission handling method 300 is suitable for the wireless access point devices 110, 120, and 130, the wireless terminal devices 111-112, 121-123, and 131-133 in the wireless communication system 100 in FIG. 1, the wireless transceiver device 200 in FIG. 2, and/or other wireless transceiver devices that support technologies such as spatial reuse and BSS coloring. The wireless transceiver device that carries out wireless transmission handling method 300 is also referred to as a BSS node. The wireless transmission handling method 300 may be performed when the BSS node detects an OBSS packet that is sent by a wireless transceiver device (hereinafter referred to as an OBSS node) in an OBSS.

First, Operation S310 is performed to estimate the path loss from the BSS node to the OBSS receiving node. The BSS node may estimate the transmission path loss from the BSS node to the OBSS receiving node by adopting an offline table creation mechanism that is described as follows. The BSS node listens to an OBSS packet sent by an OBSS node (including a packet actively sent by an OBSS transmitting node and a packet passively sent by an OBSS receiving node) in a background process thereof, and records transmission information in the OBSS packet and a received signal strength indicator (RSSI) OBSS_RSSI that is measured when listening to the OBSS packets. If the listened OBSS packet includes information of a transmission power strength OBSS_TxPWR (e.g., a trigger frame), the BSS node may calculate that the reception path loss OBSS_to_BSS_PL from the OBSS node to the BSS node is OBSS_TxPWR−OBSS_RSSI. Owing to the channel reciprocity between the BSS node and the OBSS node, the transmission path loss BSS_to_OBSS_PL from the BSS node to the OBSS node can also be estimated as OBSS_TxPWR-OBSS_RSSI.

Oppositely, if the listened OBSS packet does not include information of the transmission power strength OBSS_TxPWR, the BSS node may estimate the transmission power strength OBSS_TxPWR of the OBSS packet from the modulation and coding scheme (MCS) index in the OBBS packet by referring to a look-up table of MCS index to maximum transmission power. Then, the transmission path loss BSS_to_OBSS_PL from the BSS node to the OBSS node is calculated as OBSS_TxPWR-OBSS_RSSI according to the channel reciprocity between the BSS node and the OBSS node. The look-up table of MCS index to maximum transmission power includes MCS indices and corresponding maximum transmission powers. In general, if the MCS index is lower, the corresponding maximum transmission power is higher.

According to the above description, the BSS node may obtain the transmission path losses respectively to the OBSS nodes, and creates a path loss look-up table the BSS node in correspondence with the OBSS nodes accordingly. As such, upon subsequent detection of an OBSS packet, by the path loss look-up table created offline, the BSS node may obtain the transmission path loss to the OBSS receiving node that the destination of the OBSS packet is.

Alternatively, the BSS node may adopt an online estimation mechanism to estimate the transmission path loss from the BSS node to the OBSS receiving node. The description thereof is as follows. By receiving an OBSS packet, the BSS node obtains the transmission information in the OBSS packet and the received signal strength indicator OBSS_RSSI measured upon detection of the OBSS packet. If the OBSS packet includes information of the transmission power strength OBSS_TxPWR, the BSS node may calculate that the reception path loss OBSSTx_to_BSS_PL from the OBSS transmitting node to the BSS node is OBSS_TxPWR-OBSS_RSSI. Alternatively, if the detected OBSS packet does not include information of the transmission power strength OBSS_TxPWR, the BSS node may estimate the transmission power strength OBSS_TxPWR of the OBSS packet from the MCS index in the OBSS packet by referring to the look-up table of MCS index to maximum transmission power, and then calculates that the reception path loss OBSSTx_to_BSS_PL from the OBSS transmitting node to the BSS node is OBSS_TxPWR-OBSS_RSSI.

Furthermore, in a condition in which the wireless communication system is deployed in a high densification manner (e.g., the distance between every two nodes is less than 2 meters) and the OBSS transmitting node adopts a high MCS index (e.g., 9 or higher) to transmit the OBSS packet to an OBSS receiving node, the result that the receiving node is in proximity to the transmitting node can be inferred, and thus the reception path loss OBSSTx_to_BSS_PL from the OBSS transmitting node to the OBSS receiving node can be estimated to approximate the reception path loss from the OBSS receiving node to the BSS node accordingly, and then the transmission path loss BSS_to_OBSSRx_PL from the BSS node to the OBSS node is promptly obtained (BSS_to_OBSSRx_PL=OBSSTx_to_BSS_PL) according to the characteristics of channel reciprocity.

Then, Operation S320 is performed to determine a spatial reuse transmission power SR_TxPWR that is used to perform a spatial reuse transmission by the second wireless transceiver device according to the transmission path loss according to the transmission path loss BSS_to_OBSSRx_PL from the BSS node to the OBSS receiving node, and to obtain the power drop PWR_{drop} of the spatial reuse transmission power SR_TxPWR relative to the normal transmission power Normal_TxPWR. In a case in which the power detection parameter OBSS_PDₗₑᵥₑₗ adopted by the BSS node for detecting an OBSS packet is higher than the minimum power detection parameter OBSS_PDₘᵢₙ and less than or equal to the maximum power detection parameter OBSS_PDₘₐₓ, according to the IEEE 802.11ax Standard, the maximum transmission power SR_TxPWRₘₐₓ used by the BSS node during a power restricted stage (including the spatial reuse transmission) shall comply with the condition of Formula (1):

$${SR\_TxPWR}_{max} = {TX\_PWR}_{ref} - ( {OBSS\_PD}_{level} - {OBSS\_PD}_{min} ) , \qquad ( 1 )$$

where −82 dBm≤OBSS_PDₘᵢₙ≤OBSS_PDₘₐₓ≤−62 dBm, and the reference transmission power level TX_PWR_{ref} of the wireless transceiver device 200 is determined depending on the type thereof. For example, if the wireless transceiver device 200 is a non-AP STA, the reference transmission power level TX_PWR_{ref} is 21 dBm. If the BSS node detects that the OBSS transmitting node uses a high MCS index to perform a transmission (e.g., the MCS index of the received OBSS packet is higher than or equal to the protected MCS threshold), in order to reduce the interference to the OBSS packet during the packet transmission of the BSS node, in the embodiments of the present disclosure, the protected spatial reuse transmission power SR_TxPWR, of the BSS node estimated by utilizing a sensitivity look-up table and the transmission path loss BSS_to_OBSSRx_PL shall meet Formula (2) as follows:

$${SR\_TxPWR}_{p} = S\_tbl ( OBSS\_MCS ) + BSS\_to \_OBSSRx \_PL - PWR\_TLR , \qquad ( 2 )$$

where PWR_TLR is a power tolerance range (the interference to the OBSS packet is correspondingly lower as PWR_TLR is higher), OBSS_MCS is the MCS index of the OBSS packet, and S_tbl is a sensitivity which is a function of the MCS index. That is, S_tbl(OBSS_MCS) is the sensitivity corresponding to OBSS_MCS. The sensitivity look-up table includes data of MCS indices and corresponding sensitivities. For example, the MCS index of 0 corresponds to the sensitivity of −80 dBm, while the MCS index of 10 corresponds to the sensitivity of −60 dBm. In general, the sensitivity is correspondingly higher as the MCS index is higher. The power tolerance range PWR_TLR may be associated with the MCS index. The power tolerance range PWR_TLR may be larger as the MCS index to be protected is higher. The BSS node may create a power tolerance range look-up table in advance and stores the power tolerance range look-up table in the storage thereof, so as to select the corresponding power tolerance range PWR_TLR according to the MCS index in the OBSS packet at determining the protected spatial reuse transmission power SR_TxPWR, according to Formula (2).

In addition, the BSS node obtains the spatial reuse transmission power SR_TxPWR by further referring to the normal transmission power Normal_TxPWR that is used to transmit packets in a recent normal transmission mode, as shown in Formula (3):

$$SR\_TxPWR = min ( {SR\_TxPWR}_{max} , {SR\_TxPWR}_{p} , Normal\_TxPWR ) , \qquad ( 3 )$$

and the power drop PWR_{drop} of the spatial reuse transmission power SR_TxPWR relative to the normal transmission power Normal_TxPWR is as shown in Formula (4):

$$P W {R}_{drop} = Normal\_TxPWR - SR\_TxPWR . \qquad ( 4 )$$

Afterwards, Operation S330 is performed to determine a spatial reuse MCS index SR_Tx_MCS that is used to perform a spatial reuse transmission by the BSS node according to a normal MCS index Normal_Tx_MCS that is used to perform a normal transmission by the BSS node and the power drop PWR_{drop}. A subsequent spatial reuse can be performed in a case in which the spatial reuse MCS index SR_Tx_MCS meets a predetermined condition. In some embodiments, according to the sensitivity look-up table and in consideration of the interference by the OBSS node during the spatial reuse period in which the BSS node transmits packets, the spatial reuse MCS index SR_Tx_MCS shall comply with Formula (5) as follows:

$$S\_tbl ( SR\_Tx \_MCS ) \leq S\_tbl ( Normal\_Tx \_MCS ) - P W {R}_{drop} - PWR\_TLR . \qquad ( 5 )$$

When determining whether to perform a spatial reuse transmission, if the spatial reuse MCS index SR_Tx_MCS which meets the condition of Formula (5) can be found in the sensitivity look-up table, Operation S340 is then performed to utilize the spatial reuse MCS index SR_Tx_MCS and the spatial reuse transmission power SR_TxPWR to perform a spatial reuse transmission, i.e., spatial reuse packets are transmitted to the other BSS nodes in the same BSS by using the spatial reuse MCS index SR_Tx_MCS and the spatial reuse transmission power SR_TxPWR during the spatial reuse transmission. Oppositely, if the spatial reuse MCS index SR_Tx_MCS which meets the condition of Formula (5) cannot be found, the spatial reuse transmission can be canceled to avoid invalid transmissions and thus to save power consumption and avoid interferences to the OBSS packet.

Summing up the above description, the present disclosure provides a wireless transmission handling method which is adapted to, e.g., any one of the wireless access point devices 110, 120, and 130 and the wireless terminal devices 111-112, 121-123, and 131-133 in the wireless communication system 100 and the wireless transceiver device 200 (such as being executed by the processor 230 of the wireless transceiver device 200) and includes: estimating a transmission path loss from the wireless transceiver device to an OBSS receiving node in response to detecting an OBSS packet from an OBSS transmitting node, in which the OBSS receiving node is a destination of the OBSS packet; determining a spatial reuse transmission power that is used to perform a spatial reuse transmission by the wireless transceiver device according to the transmission path loss; determining a spatial reuse MCS index for the spatial reuse transmission according to a normal MCS index that is used to perform a normal transmission by the wireless transceiver device and a power drop of the spatial reuse transmission power that is relative to a normal transmission power used to perform the normal transmission by the wireless transceiver device; and utilizing the spatial reuse MCS index and the spatial reuse transmission power to perform the spatial reuse transmission in a case in which the spatial reuse MCS index meets a predetermined condition. In one embodiment, the spatial reuse transmission power is a smallest one of a maximum transmission power, a protected spatial reuse transmission power, and the normal transmission power, the maximum transmission power is TX_PWR_{ref}−(OBSS_PDₗₑᵥₑₗ−OBSS_PDₘᵢₙ), and the protected spatial reuse transmission power is S_tbl(OBSS_MCS)+BSS_to_OBSSRx_PL−PWR_TLR, where TX_PWR_{ref} is a reference transmission power level of the wireless transceiver device, OBSS_PDeve is a power detection parameter used to detect the OBSS packet level by the wireless transceiver device, OBSS_PDₘᵢₙ is a minimum power detection parameter, OBSS_MCS is an MCS index of the OBSS packet, S_tbl(OBSS_MCS) is a sensitivity corresponding to OBSS_MCS, BSS_to_OBSSRx_PL is the transmission path loss, and PWR_TLR is a power tolerance range. In one embodiment, the predetermined condition is S_tbl(SR_Tx_MCS)≤S_tbl(Normal_Tx_MCS)−PWR_{drop}−PWR_TLR, where SR_Tx_MCS is the spatial reuse MCS index, Normal_Tx_MCS is the normal MCS index, S_tbl(SR_Tx_MCS) and S_tbl(Normal_Tx_MCS) are sensitivities respectively corresponding to SR_Tx_MCS and Normal_Tx_MCS, PWR_{drop} is the power drop, and PWR_TLR is the power tolerance range. In one embodiment, the wireless transmission handling method (such as being executed by the processor 230 of the wireless transceiver device 200) further includes creating a path loss look-up table according to reception path losses from the wireless transceiver device to nodes in an OBSS, and obtaining the transmission path loss by the path loss look-up table. In one embodiment, the wireless transmission handling method (such as being executed by the processor 230 of the wireless transceiver device 200) further includes calculating a reception path loss from the OBSS transmitting node to the wireless transceiver device according to the OBSS packet, and obtaining the transmission path loss by the reception path loss. In one embodiment, the reception path loss is OBSS_TxPWR−OBSS_RSSI, where OBSS_TxPWR is a transmission power strength of the OBSS packet, and OBSS_RSSI is a received signal strength indicator measured from detecting the OBSS packet by the wireless transceiver device.

As can be seen from the above description, the embodiments of the present disclosure can ensure successful packet transmissions without interfering with an OBSS node, as well as simultaneously protecting a node in the same BSS for using a high MCS index to receive packets.

It will be apparent to those skilled in the art that various modifications and variations can be made to the structure of the present disclosure without departing from the scope or spirit of the present disclosure cover modifications and variations of this present disclosure provided they fall within the scope of the following claims.

What is claimed is:

1. A wireless transceiver device, comprising:
a communication module configured to receive and transmit radio frequency signals; and
a processor coupled to the communication module and configured to perform the following operations:
estimating a transmission path loss from the wireless transceiver device to an overlap basic service set (OBSS) receiving node in response to detecting, by the communication module, an OBSS packet from an OBSS transmitting node, wherein the OBSS receiving node is a destination of the OBSS packet;
determining a spatial reuse transmission power that is used to perform a spatial reuse transmission by the communication module according to the transmission path loss;
determining a spatial reuse modulation and coding scheme (MCS) index that is used to perform the spatial reuse transmission by the communication module according to a normal MCS index that is used to perform a normal transmission by the communication module and a power drop of the spatial reuse transmission power that is relative to a normal transmission power used to perform the normal transmission by the communication module; and
utilizing the spatial reuse MCS index and the spatial reuse transmission power to perform the spatial reuse transmission in a case in which the spatial reuse MCS index meets a predetermined condition.

2. The wireless transceiver device of claim 1, wherein the spatial reuse transmission power is a smallest one of a maximum transmission power, a protected spatial reuse transmission power, and the normal transmission power, the maximum transmission power is TX_PWR_{ref}−(OBSS_PDₗₑᵥₑₗ−OBSS_PD, and the protected spatial reuse transmission power is S_tbl(OBSS_MCS)+BSS_to_OBSSRx_PL-PWR_TLR, where TX_PWR_{ref} is a reference transmission power level of the communication module, OBSS_PD, is a power detection parameter used to detect the OBSS packet by the communication module, OBSS_PDₘᵢₙ is a minimum power detection parameter, OBSS_MCS is an MCS index of the OBSS packet, S_tbl(OBSS_MCS) is a sensitivity corresponding to OBSS_MCS, BSS_to_OBSSRx_PL is the transmission path loss, and PWR_TLR is a power tolerance range.

3. The wireless transceiver device of claim 2, wherein the predetermined condition is:
S_tbl(SR_Tx_MCS)≤S_tbl(Normal_Tx_MCS)−PWR_{drop}−PWR_TLR,
where SR_Tx_MCS is the spatial reuse MCS index, Normal_Tx_MCS is the normal MCS index, S_tbl(SR_Tx_MCS) and S_tbl(Normal_Tx_MCS) are sensitivities respectively corresponding to SR_Tx_MCS and Normal_Tx_MCS, PWR_{drop} is the power drop, and PWR_TLR is the power tolerance range.

4. The wireless transceiver device of claim 1, wherein the processor is configured to create a path loss look-up table according to reception path losses from the wireless transceiver device to nodes in an OBSS and obtain the transmission path loss by the path loss look-up table.

5. The wireless transceiver device of claim 1, wherein the processor is configured to calculate a reception path loss from the OBSS transmitting node to the wireless transceiver device according to the OBSS packet and obtain the transmission path loss by the reception path loss.

6. The wireless transceiver device of claim 5, wherein the reception path loss is OBSS_TxPWR−OBSS_RSSI, where OBSS_TxPWR is a transmission power strength of the OBSS packet, and OBSS_RSSI is a received signal strength indicator measured from detecting the OBSS packet by the communication module.

7. The wireless transceiver device of claim 6, wherein the transmission power strength OBSS_TxPWR is estimated by the processor according to an MCS index in the OBSS packet.

8. A wireless transmission handling method adapted to a wireless transceiver device, the wireless transmission handling method comprising:
estimating a transmission path loss from the wireless transceiver device to an OBSS receiving node in response to detecting an OBSS packet from an OBSS transmitting node, wherein the OBSS receiving node is a destination of the OBSS packet;
determining a spatial reuse transmission power that is used to perform a spatial reuse transmission by the wireless transceiver device according to the transmission path loss;
determining a spatial reuse MCS index for the spatial reuse transmission according to a normal MCS index that is used to perform a normal transmission by the wireless transceiver device and a power drop of the spatial reuse transmission power that is relative to a normal transmission power used to perform the normal transmission by the wireless transceiver device; and
utilizing the spatial reuse MCS index and the spatial reuse transmission power to perform the spatial reuse transmission in a case in which the spatial reuse MCS index meets a predetermined condition.

9. The wireless transmission handling method of claim 8, wherein the spatial reuse transmission power is a smallest one of a maximum transmission power, a protected spatial reuse transmission power, and the normal transmission power, the maximum transmission power is TX_PWR_{ref}−(OBSS_PDjevel−OBSS_PDₘᵢₙ), and the protected spatial reuse transmission power is S_tbl(OBSS_MCS)+BSS_to_OBSSRx_PL−PWR_TLR, where TX_PWR_{ref} is a reference transmission power level of the wireless transceiver device, OBSS_PDₗₑᵥₑₗ is a power detection parameter used to detect the OBSS packet by the wireless transceiver device, OBSS_PDₘᵢₙ is a minimum power detection parameter, OBSS_MCS is an MCS index of the OBSS packet, S_tbl(OBSS_MCS) is a sensitivity corresponding to OBSS_MCS, BSS_to_OBSSRx_PL is the transmission path loss, and PWR_TLR is a power tolerance range.

10. The wireless transmission handling method of claim 9, wherein the predetermined condition is:
S_tbl(SR_Tx_MCS)≤S_tbl(Normal_Tx_MCS)−PWR_{drop}−PWR_TLR,
where SR_Tx_MCS is the spatial reuse MCS index, Normal_Tx_MCS is the normal MCS index, S_tbl(SR_Tx_MCS) and S_tbl(Normal_Tx_MCS) are sensitivities respectively corresponding to SR_Tx_MCS and Normal_Tx_MCS, PWR_{drop} is the power drop, and PWR_TLR is the power tolerance range.

11. The wireless transmission handling method of claim 8, further comprising:
creating a path loss look-up table according to reception path losses from the wireless transceiver device to nodes in an OBSS, and obtaining the transmission path loss by the path loss look-up table.

12. The wireless transmission handling method of claim 8, further comprising:
calculating a reception path loss from the OBSS transmitting node to the wireless transceiver device according to the OBSS packet, and obtaining the transmission path loss by the reception path loss.

13. The wireless transmission handling method of claim 12, wherein the reception path loss is OBSS_TxPWR-OBSS_RSSI, where OBSS_TxPWR is a transmission power strength of the OBSS packet, and OBSS_RSSI is a received signal strength indicator measured from detecting the OBSS packet by the wireless transceiver device.

14. A wireless communication system, comprising:
a first wireless transceiver device; and
a second wireless transceiver device configured to wirelessly communication connect to the first wireless transceiver device and belonging to the same basic service set (BSS) as the first wireless transceiver device, the second wireless transceiver device configured to perform the following operations:
estimating a transmission path loss from the second wireless transceiver device to an OBSS receiving node in response to detecting an OBSS packet from an OBSS transmitting node, wherein the OBSS receiving node is a destination of the OBSS packet;
determining a spatial reuse transmission power that is used to perform a spatial reuse transmission by the second wireless transceiver device according to the transmission path loss;
determining a spatial reuse MCS index for the spatial reuse transmission according to a normal MCS index that is used to perform a normal transmission by the second wireless transceiver device and a power drop of the spatial reuse transmission power that is relative to a normal transmission power used to perform the normal transmission by the second wireless transceiver device; and
utilizing the spatial reuse MCS index and the spatial reuse transmission power to perform the spatial reuse transmission in a case in which the spatial reuse MCS index meets a predetermined condition.

15. The wireless communication system of claim 14, wherein the spatial reuse transmission power is a smallest one of a maximum transmission power, a protected spatial reuse transmission power, and the normal transmission power, the maximum transmission power is TX_PWR_{ref}−(OBSS_PDₗₑᵥₑₗ−OBSS_PDₘᵢₙ), and the protected spatial reuse transmission power is S_tbl(OBSS_MCS)+BSS_to_OBSSRx_PL−PWR_TLR, where TX_PWR_{ref} is a reference transmission power level of the second wireless transceiver device, OBSS_PDₗₑᵥₑₗ is a power detection parameter used to detect the OBSS packet by the second wireless transceiver device, OBSS_PDₘᵢₙ is a minimum power detection parameter, OBSS_MCS is an MCS index of the OBSS packet, S_tbl(OBSS_MCS) is a sensitivity corresponding to OBSS_MCS, BSS_to_OBSSRx_PL is the transmission path loss, and PWR_TLR is a power tolerance range.

16. The wireless communication system of claim 15, wherein the predetermined condition is:
S_tbl(SR_Tx_MCS)≤S_tbl(Normal_Tx_MCS)−PWR_{drop}−PWR_TLR,
where SR_Tx_MCS is the spatial reuse MCS index, Normal_Tx_MCS is the normal MCS index, S_tbl(SR_Tx_MCS) and S_tbl(Normal_Tx_MCS) are sensitivities respectively corresponding to SR_Tx_MCS and Normal_Tx_MCS, PWR_{drop} is the power drop, and PWR_TLR is the power tolerance range.

17. The wireless communication system of claim 14, wherein the second wireless transceiver device is configured to create a path loss look-up table according to reception path losses from the second wireless transceiver device to nodes in an OBSS and obtain the transmission path loss by the path loss look-up table.

18. The wireless communication system of claim 14, wherein the second wireless transceiver device is configured to calculate a reception path loss from the OBSS transmitting node to the second wireless transceiver device according to the OBSS packet and obtain the transmission path loss by the reception path loss.

19. The wireless communication system of claim 18, wherein the reception path loss is OBSS_TxPWR-OBSS_RSSI, where OBSS_TxPWR is a transmission power strength of the OBSS packet, and OBSS_RSSI is a received signal strength indicator measured from detecting the OBSS packet by the second wireless transceiver device.

20. The wireless communication system of claim 14, wherein the second wireless transceiver device transmits a spatial reuse packet to the first wireless transceiver device in the spatial reuse MCS index and the spatial reuse transmission power during a period of the spatial reuse transmission.
